(19) United States
(12) Patent Application Publication
(10) Pub. No.: US 2026/0098479 A1
(43) Pub. Date: Apr. 9, 2026

(54) RAM AIR TURBINE FIXED WITHIN AIRCRAFT WITH ENERGY RECOVERY FROM VENTED CABIN AIR

(71) Applicant: Hamilton Sundstrand Corporation, Charlotte, NC (US)

(72) Inventors: Viktor Kilchyk, Williamsville, NY (US); Debabrata Pal, Hoffman Estates, IL (US)

(21) Appl. No.: 18/909,430

(22) Filed: Oct. 8, 2024

(51) Int. Cl. F01D 15/10; B64D 13/06; B64D 41/00

(52) U.S. Cl. CPC F01D 15/10; B64D 13/06; B64D 2013/0648; B64D 41/007; F05D 2220/34; F05D 2220/768

(57) ABSTRACT

An aircraft system, having: a section of a fuselage surrounding an interior portion of an aircraft; an aperture defined along the section of the fuselage; an inlet scoop at the aperture; an inlet channel extending away from the inlet scoop to the interior portion of the aircraft; a Ram Air Turbine (RAT) connected to the inlet channel, wherein the RAT is fixed within the interior portion of the aircraft; a cabin air vent; and a second channel extending from the cabin air vent to the RAT so that cabin air mixes with an airflow in the inlet channel when flowing into the RAT.

### BACKGROUND

The embodiments are directed to Ram Air Turbines (RAT) and more specifically to a RAT fixed within an aircraft that recovers energy from vented cabin air.

A RAT may be deployed outside of aircraft. Such a configuration may require a mechanically complex, heavy and space occupying deployment and stowing system. A deployed RAT may experience lower efficiency due to aerodynamic losses, turbulence, and tip vortices. They may generate noise pollution and be vulnerable to damage from environmental debris.

### BRIEF SUMMARY

Disclosed is an aircraft system, including: a section of a fuselage surrounding an interior portion of an aircraft; an aperture defined along the section of the fuselage; an inlet scoop at the aperture; an inlet channel extending away from the inlet scoop to the interior portion of the aircraft; a Ram Air Turbine (RAT) connected to the inlet channel, wherein the RAT is fixed within the interior portion of the aircraft; a cabin air vent; and a second channel extending from the cabin air vent to the RAT so that cabin air mixes with an airflow in the inlet channel when flowing into the RAT.

In addition to one or more aspects of the above disclosed system, or as an alternate, the system includes: a duct that surrounds the RAT, the duct extending from a forward end to an aft end, wherein the inlet channel and the second channel are fluidly coupled to the forward end of the duct; and an exit nozzle at the connected to the aft end of the duct.

In addition to one or more aspects of the above disclosed system, or as an alternate, the system includes a variable area inlet nozzle disposed at the forward end of the duct.

In addition to one or more aspects of the above disclosed system, or as an alternate, the RAT is a rim driven turbine.

In addition to one or more aspects of the above disclosed system, or as an alternate, the RAT includes a rotor defining blades, and a duct surrounds the rotor to define a stator.

In addition to one or more aspects of the above disclosed system, or as an alternate, the duct includes copper windings.

In addition to one or more aspects of the above disclosed system, or as an alternate, the blade defines blade tips, and one of: a shroud is integral with the blade tips, and permanent magnets are mounted to the shroud; or the permanent magnets are integrated into the blade tips.

In addition to one or more aspects of the above disclosed system, or as an alternate, a pitch of the blades is controllable to control a speed of the RAT and/or power generation by the RAT.

In addition to one or more aspects of the above disclosed system, or as an alternate, the RAT is hub-less.

In addition to one or more aspects of the above disclosed system, or as an alternate, the RAT is configured as an induction motor-generator.

In addition to one or more aspects of the above disclosed system, or as an alternate, the blades define blade tips, and one of: a shroud is integral with the blade tips, and the shroud includes a conductor; or induction bars integrated into the blade tips.

In addition to one or more aspects of the above disclosed system, or as an alternate, the RAT includes a center shaft that is coupled to a motor-generator.

Disclosed is another embodiment of the aircraft system, including: a fuselage surrounding an interior portion of an aircraft; wherein the fuselage defines a forward portion and an aft portion, wherein the fuselage defines stagnation zones including a first stagnation zone in the forward portion and a second stagnation zone in the aft portion; a first aperture defined at the first stagnation zone and a second aperture defined at the second stagnation zone; an inlet scoop at the first aperture; an exhaust vent at the second aperture; an inlet channel extending away from the inlet scoop to the interior portion of the aircraft; a Ram Air Turbine (RAT) connected to the inlet channel, wherein the RAT is fixed within the interior portion of the aircraft; and a cabin air vent; and a second channel extending from the cabin air vent to the RAT so that cabin air mixes with an airflow in the inlet channel when flowing into the RAT; and an outlet channel extending from the RAT to the exhaust vent.

In addition to one or more aspects of the above disclosed another embodiment of the system, or as an alternate, the system includes: a duct that surrounds the RAT, the duct extending from a forward end to an aft end, wherein the inlet channel and the second channel are fluidly coupled to the forward end; and an exit nozzle at the connected to the aft end of the duct.

In addition to one or more aspects of the above disclosed another embodiment of the system, or as an alternate, the system includes: a variable area inlet nozzle disposed at the forward end of the duct.

In addition to one or more aspects of the above disclosed another embodiment of the system, or as an alternate, the RAT includes blades and a pitch of the blades is controllable to control a speed of the RAT and/or power generation by the RAT.

In addition to one or more aspects of the above disclosed another embodiment of the system, or as an alternate, the aircraft has a wing and the first stagnation zone adjacent to the wing.

In addition to one or more aspects of the above disclosed another embodiment of the system, or as an alternate, the aircraft has a tail assembly and the second stagnation zone adjacent to the tail assembly.

In addition to one or more aspects of the above disclosed another embodiment of the system, or as an alternate: the aircraft includes a plurality of aft stagnation zones, including the second stagnation zone, distributed about the tail assembly; and a flow splitter is located in the outlet channel, whereby the outlet channel branches to two or more of the aft stagnation zones.

In addition to one or more aspects of the above disclosed another embodiment of the system, or as an alternate, the RAT is configured as an induction motor-generator.

### BRIEF DESCRIPTION OF THE DRAWINGS

The following descriptions should not be considered limiting in any way. With reference to the accompanying drawings, like elements are numbered alike:

FIG. 1 shows an aircraft that may utilize aspects of the disclosed embodiments;

FIG. 2 shows a RAT fixed within a section of the aircraft;

FIG. 3 shows details of the RAT configured as a permanent magnet motor-generator;

FIG. 4 shows details of the RAT configured as an induction motor-generator;

FIG. 5 shows a hub-less configuration of a turbine utilized for the RAT according to an embodiment; and

FIG. 6 shows the RAT connected between forward and aft stagnation zones along the fuselage of the aircraft.

### DETAILED DESCRIPTION

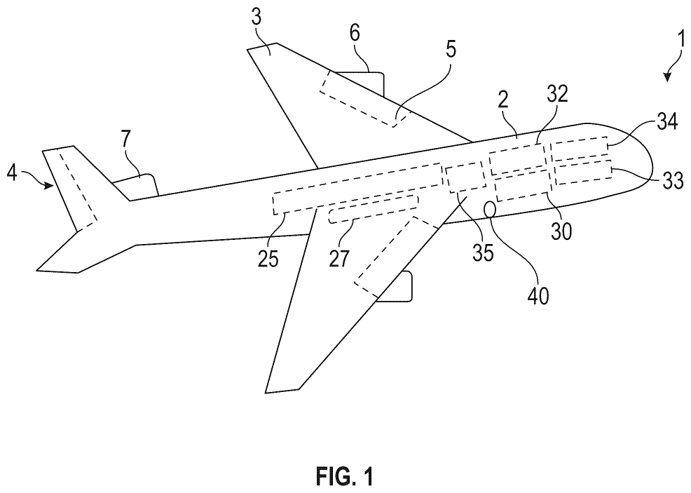

FIG. 1 shows an aircraft 1 having a fuselage 2 with a wing 3 and tail assembly 4, which may have control surfaces 5. The wing 3 may include an engine 6, such as a gas turbine engine, and an auxiliary power unit 7 may be disposed at the tail assembly 4. The aircraft 1 may have a cabin 25, a cargo bay 27, an environmental control system (ECS) 30 for conditioning the cabin 25 and/or cargo bay 27. The ECS 30 may include a vapor compression system (VCS) 32 that cools air directed to, e.g., the cargo bay 27 and provides refrigeration to one or more systems 35 of the aircraft 1, and an air cycle machine (ACM) 33 that cools air directed to e.g., the cabin 25. A RAM air inlet 40 may scoop ambient air for the ECS 30, or the ECS 30 may receive cabin vent air recirculated from, e.g., a cabin air compressor (CAC) 34.

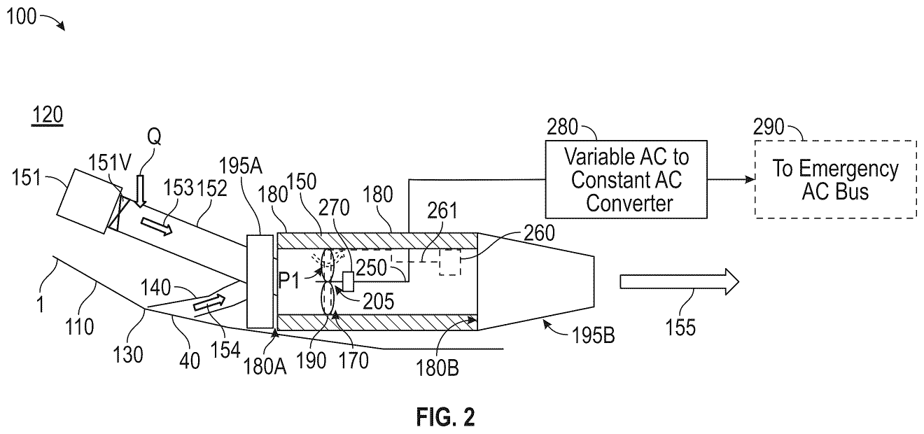

Turning to FIG. 2, a disclosed system 100 includes a section 110 of the fuselage 2 surrounding an interior portion 120 of the aircraft 1. An inlet aperture 130 is defined along the section 110 of the fuselage 2. An inlet scoop 40, e.g., the RAM air inlet 40 (FIG. 1), is located the aperture 130. An inlet channel 140 extends away from the inlet scoop 40 to the interior portion 120 of the aircraft 1.

According to an embodiment, a Ram Air Turbine (RAT) 150 is connected to the inlet channel 140. The RAT 150 is fixed within the interior portion 120 of the aircraft 1. In one embodiment, the RAT 150 is a rim driven turbine. A cabin air vent 151 may be connected to the RAT 150 via a second channel 152. This configuration mixes cabin air 153 with ambient air 154 flowing to the RAT 150. This configuration adds energy Q to the ambient air 154 to increase power to the RAT 150, recovering energy available from the cabin vent air 153.

In one embodiment, a duct 180 surrounds the RAT 150. The duct 180 may extend from a forward end 180A to an aft end 180B. The inlet channel 140 and second channel 152 are fluidly coupled to the forward end 180A of the duct 180. A variable area inlet nozzle 195A is optionally disposed at the forward end of the duct 180. An exit nozzle 195B is optionally connected to the aft end 180B of the duct 180 for efficient venting of air downstream from the RAT 150 and to provide supplementary thrust to the aircraft 1. The ducts 195A, 195B may also be utilized, separately or together, to control the speed of the RAT 150 during variable flight conditions. The cabin air vent 151 may include electrically or pneumatically operated valve 151V to limit or control the air flow through the duct 152 such that cabin air pressure is maintained at predetermined safe and adequate level.

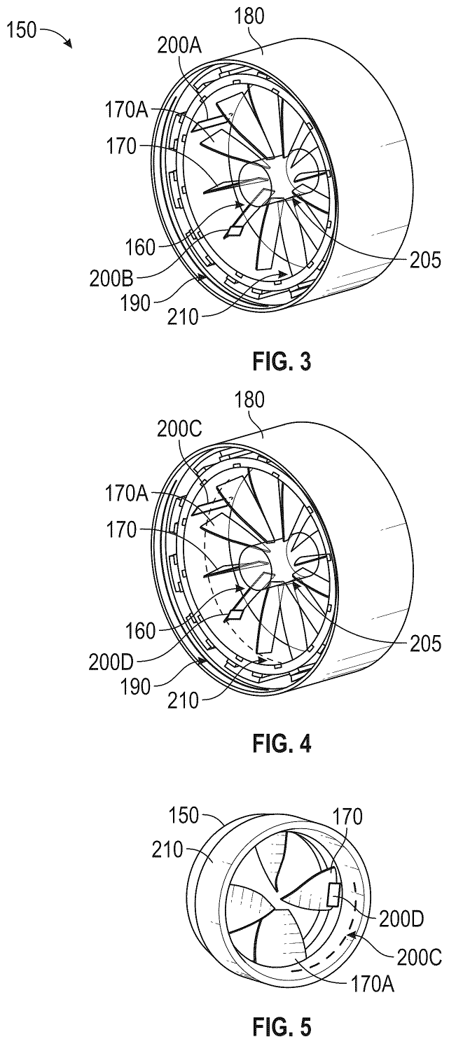

As shown in FIG. 3, in one embodiment, the RAT 150 is configured as a permanent magnet motor-generator. The RAT 150 includes a rotor 160 defining blades 170 and the duct 180 surrounds the rotor 160. The duct 180 includes copper windings 190 and defines a stator. Permanent magnets 200A may be seated in a shroud 210 that is integral with the blade tips 170A. Alternatively, the permanent magnets 200B are integral with the blade tips 170A.

As shown in FIG. 4, in one embodiment, the RAT 150 is configured as an induction motor-generator. The RAT 150 includes a rotor 160 defining blades 170 and a duct 180 surrounding the rotor 160. The duct 180 includes copper windings 190 and defines a stator. The shroud 210 is integral with the blade tips 170A, and the shroud 210 includes a conductor 200C. Alternatively, induction bars 200D are integral with the blade tips 170A.

The RAT 150 may have a blade hub 205 (FIGS. 2 through 4) or be hub-less (FIG. 5). In a hub-less configuration, blades 170 of the RAT 150 are connected directly to the shroud 210. The shroud 210 may be configured with magnets 200A, a conductor 200C or with induction bars 200D at the blade tips 170A as indicated above for generating current. RAT 150 without a hub may provide for a greater thrust and torque coefficient than can be achieved by a configuration with a hub 205, allowing for greater power generation by the RAT 150.

In one embodiment, the RAT 150 includes a center shaft 250 that is coupled to a motor-generator 260 (FIG. 2, shown schematically) via electrical leads 261 coupled to the outer stator 190. In one embodiment, a governor 270 controls a rotational speed of the RAT 150. In one embodiment, the blades 170 of the RAT 150 are configured for a variable pitch P1 to control speed of the RAT 150 and/or the current generated by the RAT 150. Current that is generated by the RAT 150 maybe be received by a variable AC to constant AC converter 280 and directed to an emergency AC bus 290 for the aircraft 1.

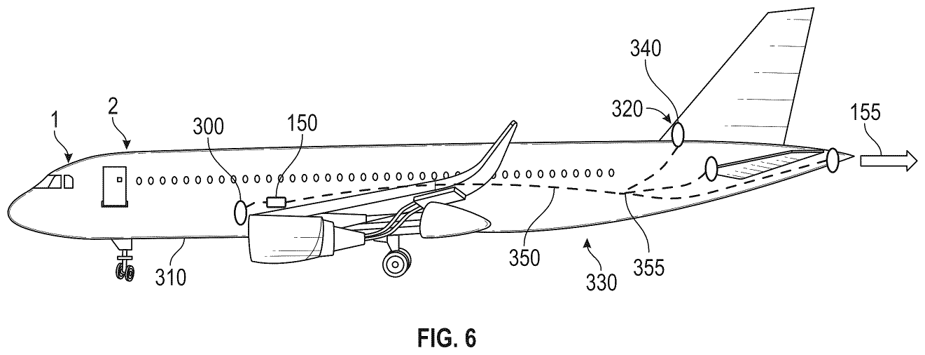

Turning to FIG. 6, in one embodiment the inlet aperture 130 is located a forward (first) stagnation zone 300 of the fuselage 2 of the aircraft 1, which may be a forward portion 310 of the fuselage 2, e.g., adjacent to the wing 3. An aft (second) stagnation zone 320 may be located at an aft portion 330 of the fuselage 2. A second aperture 340 may be defined at the aft stagnation zone 320, e.g., adjacent to the tail section 4. An outlet channel 350 may be connected between the RAT 150 and the second aperture 340. For example, the exit nozzle 195B (FIG. 2) for the RAT 150 may be located at the end of the outlet channel 350, or the outlet channel 350 may extend aft from the exit nozzle 195B. In one embodiment, there may be a plurality of aft stagnation zones 320 and the outlet channel 350 may branch to two or more of the aft stagnation zones 320, e.g., via a flow splitter 355 located at a junction 360 in the channel 350. This configuration enables, e.g., the use of the RAT 150 for energy recovery during a decent phase of flight.

The embodiments provide an internally fixed RAT 150 that will avoid issues with a deployable RAT, such a complex, heavy and space occupying mechanism, exterior noise generation, aerodynamic inefficiencies and susceptibility to damage from environmental debris. The disclosed RAT 150 may be used for energy recovery, e.g., from cabin vent air 153, and/or during a decent, e.g., with a location of the RAT 150 the inlet and outlet being selected to maximize performance near the fuselage stagnation zones.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An aircraft system, comprising:
a section of a fuselage surrounding an interior portion of an aircraft;
an aperture defined along the section of the fuselage;
an inlet scoop at the aperture;
an inlet channel extending away from the inlet scoop to the interior portion of the aircraft;
a Ram Air Turbine (RAT) connected to the inlet channel, wherein the RAT is fixed within the interior portion of the aircraft;
a cabin air vent; and
a second channel extending from the cabin air vent to the RAT so that cabin air mixes with an airflow in the inlet channel when flowing into the RAT.

2. The system of claim 1, further including:
a duct that surrounds the RAT, the duct extending from a forward end to an aft end,
wherein the inlet channel and the second channel are fluidly coupled to the forward end of the duct; and
an exit nozzle at the connected to the aft end of the duct.

3. The system of claim 2, further including
a variable area inlet nozzle disposed at the forward end of the duct.

4. The system of claim 1, wherein the RAT is a rim driven turbine.

5. The system of claim 4, wherein the RAT includes a rotor defining blades, and a duct surrounds the rotor to define a stator.

6. The system of claim 5, wherein the duct includes copper windings.

7. The system of claim 6, wherein
the blades define blade tips, and one of:
a shroud is integral with the blade tips, and permanent magnets are mounted to the shroud; or
the permanent magnets are integrated into the blade tips.

8. The system of claim 5, wherein a pitch of the blades is controllable to control a speed of the RAT and/or power generation by the RAT.

9. The system of claim 5, wherein the RAT is hub-less.

10. The system of claim 6, wherein the RAT is configured as an induction motor-generator.

11. The system of claim 10, wherein
the blades define blade tips, and one of:
a shroud is integral with the blade tips, and the shroud includes a conductor; or
induction bars integrated into the blade tips.

12. The system of claim 1, wherein the RAT includes a center shaft that is coupled to a motor-generator.

13. An aircraft system, comprising:
a fuselage surrounding an interior portion of an aircraft;
wherein the fuselage defines a forward portion and an aft portion, wherein the fuselage defines stagnation zones including a first stagnation zone in the forward portion and a second stagnation zone in the aft portion;
a first aperture defined at the first stagnation zone and a second aperture defined at the second stagnation zone;
an inlet scoop at the first aperture;
an exhaust vent at the second aperture;
an inlet channel extending away from the inlet scoop to the interior portion of the aircraft;
a Ram Air Turbine (RAT) connected to the inlet channel, wherein the RAT is fixed within the interior portion of the aircraft; and
a cabin air vent; and
a second channel extending from the cabin air vent to the RAT so that cabin air mixes with an airflow in the inlet channel when flowing into the RAT; and
an outlet channel extending from the RAT to the exhaust vent.

14. The system of claim 13, further including:
a duct that surrounds the RAT, the duct extending from a forward end to an aft end, wherein the inlet channel and the second channel are fluidly coupled to the forward end; and
an exit nozzle at the connected to the aft end of the duct.

15. The system of claim 14, further including:
a variable area inlet nozzle disposed at the forward end of the duct.

16. The system of claim 13, wherein the RAT comprises blades and a pitch of the blades is controllable to control a speed of the RAT and/or power generation by the RAT.

17. The system of claim 13, wherein the aircraft has a wing and the first stagnation zone adjacent to the wing.

18. The system of claim 13, wherein the aircraft has a tail assembly and the second stagnation zone adjacent to the tail assembly.

19. The system of claim 18, wherein:
the aircraft includes a plurality of aft stagnation zones, including the second stagnation zone, distributed about the tail assembly; and
a flow splitter is located in the outlet channel, whereby the outlet channel branches to two or more of the aft stagnation zones.

20. The system of claim 13, wherein the RAT is configured as an induction motor-generator.
